(19) United States
(12) Patent Application Publication
(10) Pub. No.: US 2025/0260201 A1
(43) Pub. Date: Aug. 14, 2025

(54) HIGH-SPEED MODULAR INTERCONNECT

(71) Applicant: ITT Manufacturing Enterprises, LLC, Stamford, CT (US)

(72) Inventors: Hung Duc TRAN, Santa Ana, CA (US); Hong NGUYEN, Santa Ana, CA (US)

(73) Assignee: ITT Manufacturing Enterprises, LLC, Stamford, CT (US)

(21) Appl. No.: 18/949,941

(22) Filed: Nov. 15, 2024

Related U.S. Application Data
(60) Provisional application No. 63/552,236, filed on Feb. 12, 2024.

(51) Int. Cl. H01R 13/6586; H01R 13/52; H01R 13/642; H01R 43/20

(52) U.S. Cl. CPC H01R 13/6586; H01R 13/5208; H01R 13/642; H01R 43/20

(57) ABSTRACT

A modular interconnect system is described for high-speed applications. Low speed signal pins including power, ground, and other low frequency communications may be combined in a first connector while high speed signal pins may be provided in one or more separate connectors with the wiring bundled together. Each connector and associated wiring may have separate shielding. The high-speed connectors may include differential or single-ended signal pins. The high-speed connectors may also include a mechanical polarity indicator such as a protrusion.

### CROSS-REFERENCE TO RELATED APPLICATIONS

This application claims priority to U.S. Provisional Patent Application Ser. No. 63/552,236 filed on Feb. 12, 2024. The disclosures of the Provisional Application are hereby incorporated by reference in their entirety BACKGROUND

Unless otherwise indicated herein, the materials described in this section are not prior art to the claims in this application and are not admitted as prior art by inclusion in this section.

Connectors are electro-mechanical components that provide for exchange of power and/or communication (e.g., data) signals between distinct electrical devices and systems. A typical connector system includes a plug and a receptacle, which fit together mechanically and provides one or more electrical connections. The mechanical portion may include various forms of coupling such as threaded coupling, click-on coupling, pressure-fit coupling, and similar ones. Depending on a purpose and functionality of a connector system, various materials such as plastic, metal, ceramic, etc. may be used. Connectors may include additional functionalities such as environmental protection, heat resistance, electromagnetic shielding, and so on. Some connector systems are standardized, where size, dimension, signal levels, or even materials are defined by an industry or government standard. Other connectors systems may be proprietary.

Radio frequency interference (RFI) is the presence of unwanted signals or electrical energy that detrimentally impact an electronic system. The causes of RFI interference include external, naturally occurring sources like thunderstorms and static electricity, as well as man-made sources created through out-of-band transmissions, radiation from network antennas and cabling, and the proximity of adjacent networks operating on overlapping frequencies. As electronic systems evolve, interconnect systems carry increasing number of signals. Furthermore, as devices become more compact, connectors also become compact, where pins carrying different signals at different frequencies become closer and closer to each other, which may result in worsening of RFI impact.

### SUMMARY

The present disclosure generally describes high-speed modular interconnect systems with improved radio frequency interference (RFI) performance.

According to some examples, a modular interconnect system may include a low-speed connector assembly that includes a conductive frame; a dielectric holder within the conductive frame, the dielectric holder having a plurality of longitudinally extending passages; a plurality of contacts within the plurality of passages; and a plurality of low-speed wires electrically connected to the plurality of contacts. The modular interconnect system may also include one or more high-speed connector assemblies, each high-speed connector assembly may include a conductive frame; a dielectric holder within the conductive frame, the dielectric holder having a pair of longitudinally extending passages; a pair of contacts within the pair passages; and a pair of high-speed wires electrically connected to the pair of contacts, where the plurality of low-speed wires are shielded together and each pair of high-speed wires are shielded together.

According to further examples, a modular high-speed connector assembly may include a conductive frame; a dielectric holder within the conductive frame, the dielectric holder having a pair of longitudinally extending passages; a pair of contacts within the pair passages arranged as one of a differential signal pair or signal and ground pair of a single-ended signal; and a pair of high-speed wires electrically connected to the pair of contacts and shielded together, where one or more modular high-speed connector assemblies are integrated with a low-speed connector assembly in a modular mix-mode interconnect system.

According to some examples, a method of assembling a modular interconnect system may include assembling a low-speed connector assembly by positioning a first dielectric holder within a first conductive frame, the first dielectric holder having a plurality of longitudinally extending passages; positioning a plurality of contacts within the plurality of passages; and electrically connecting a plurality of low-speed wires to the plurality of contacts. The method may further include assembling one or more high-speed connector assemblies, by for each high-speed connector assembly, positioning a second dielectric holder within a second conductive frame, the second dielectric holder having a pair of longitudinally extending passages; positioning a pair of contacts within the pair passages; electrically connecting a pair of high-speed wires to the pair of contacts; shielding the plurality of low-speed wires together; and shielding each pair of high-speed wires together.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1A illustrates an example high-speed modular interconnect system with a shielding configuration;

FIG. 1B illustrates an example high-speed modular interconnect system with another shielding configuration;

FIG. 2 illustrates an example high-speed modular interconnect system with an example wiring configuration;

FIG. 3 illustrates front sectional view of an example high-speed modular interconnect system with individual contacts;

FIG. 4A through 4F illustrate various views of an example 24-position mix-mode modular interconnect system;

FIGS. 5A and 5B illustrate various views of an example 23-position circular mix-mode modular interconnect system; and

FIG. 6 illustrates an example 22-position circular mix-mode modular interconnect system,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods of manufacture, apparatus, systems and/or devices associated with high-speed modular interconnect systems with improved radio frequency interference (RFI) performance.

Briefly stated, a modular interconnect system is described for high-speed applications. Low speed signal pins including power, ground, and other low frequency communications may be combined in a first connector while high speed signal pins may be provided in one or more separate connectors with the wiring bundled together. In some examples, each connector and associated wiring may have separate shielding. The high-speed connectors may include differential or single-ended signal pins. The high-speed connectors may also include a mechanical polarity indicator such as a protrusion.

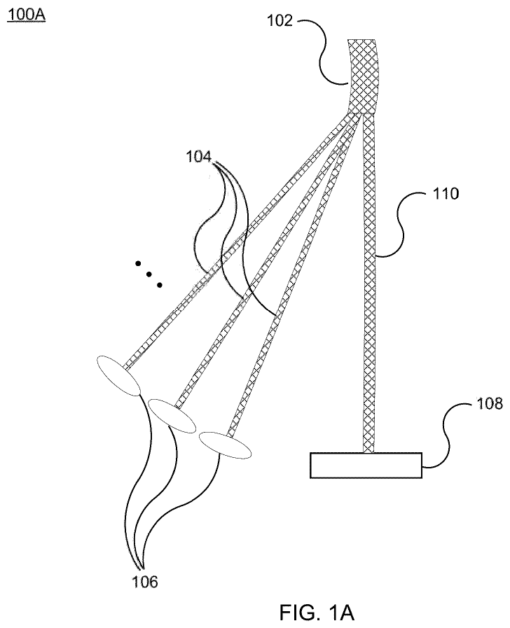

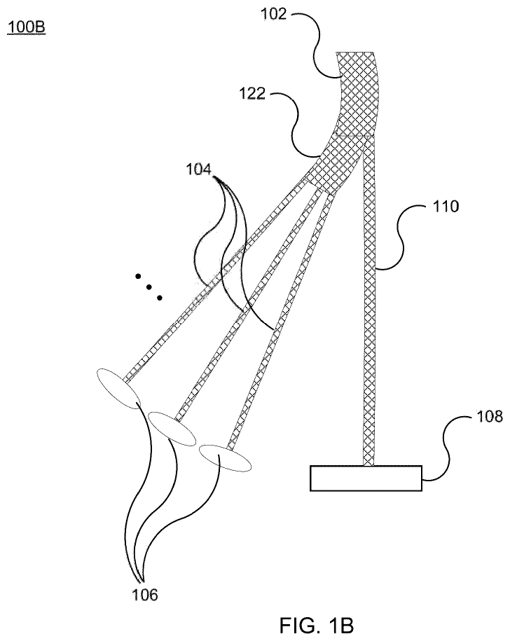

FIG. 1A illustrates an example high-speed modular interconnect system with a shielding configuration, arranged in accordance with at least some embodiments described herein.

Diagram 100A in FIG. 1 includes components of a high-speed modular interconnect system with a low-speed connector 108, high-speed connectors 106, shielded wiring receptacle of the low-speed connector, shielded wirings housing 106, end cap 102, end seal 104, secondary of the high-speed connectors, and the shielded cable 102 for the entire interconnect system.

With the proliferation of electronic devices and peripherals, the variety and number of interconnectivity mechanisms including different power and communication cabling in residential, industrial, automotive, and other industries has increased dramatically. While wireless connectivity is increasingly popular, some environments (e.g., higher electromagnetic noise environments, secure communication needs, etc.) still require wired connections. Especially in demanding environments (e.g., military use, mobile environments, hazardous environments, etc.), connectors need to be robust and resistant to environmental hazards such as RFI for reliable performance.

Despite a variety of noise mitigation measures such as RFI filters, grounding, shielding, etc., many wires in a multi-purpose connector tend to carry and transmit noise to the environment and to other wires within the cable. For example, wires carrying power for an electronic device may carry and transmit noise from power supplies (e.g., switching power supplies), oscillators in electronic devices may present higher frequency noise into cabling, etc. As interconnect systems become more compact and larger amounts of data is carried over data wires, noise from adjacent wires in the cabling of an interconnect system become an increasing challenge. Additional grounding may help mitigate RFI challenges to a degree in interconnect cabling, but may become inadequate at higher data exchange rates and smaller connectors.

In accordance with some examples, a compact, modular interconnect system is provided, where low frequency signal carrying wires may be grouped in the low-speed connector 108. High-speed signal carrying wires may be separated and grouped in individual high-speed connectors 106. For example, each high-speed connector may include two pins (a differential signal pair or signal and ground pair of single-ended signal). The wiring for the low-speed connector 108 may be shielded separately from the wirings of the high-speed connectors 106. The wirings of each high-speed connector may also be shielded separately. The separate wirings may be bundled into the interconnect cable, which may itself be shielded as well. The separate shielding and the physical separation of the high-speed connectors from the low-speed connector may mitigate any RFI leakage from the low-speed wirings into the high-speed wirings.

FIG. 1B illustrates an example high-speed modular interconnect system with another shielding configuration, arranged in accordance with at least some embodiments described herein.

The configuration in diagram 100B of FIG. 1B is similar to the configuration in diagram 100A with a difference: in some examples, the high-speed wirings may include a secondary shield 122 over their individual shields bundling the high-speed wirings before all wires are bundled in the cable 102. This secondary shielding may provide additional robustness against RFI leakage from the low-speed wires.

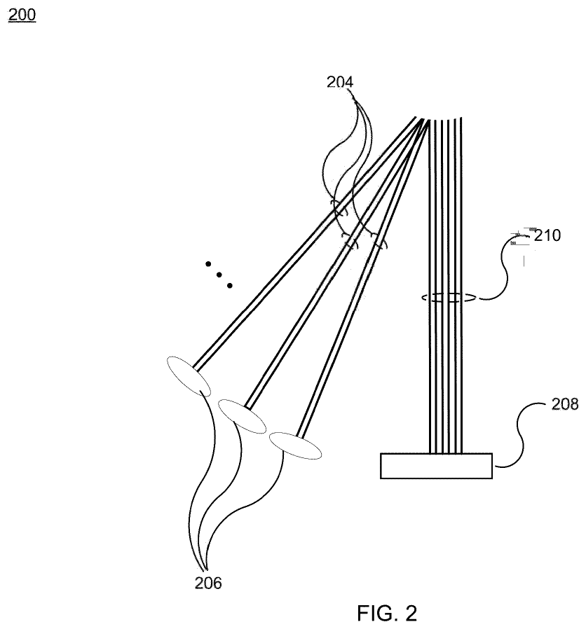

FIG. 2 illustrates an example high-speed modular interconnect system with an example wiring configuration, arranged in accordance with at least some embodiments described herein.

Diagram 200 in FIG. 2 shows wire pairs 204 for each of the high-speed connectors 206 and wires 210 for the low-speed connector 208. As mentioned herein, the high-speed wires may carry a differential signal or a single-ended signal. A material (e.g., copper, gold, steel, etc.), type (braided, solid, bundled), and a thickness of the wires may be selected based on a type of signal to be carried, an application for the interconnect system, etc.

The connectors may include a conductive frame, insulative (dielectric) holders in the frame and passages, and contacts mounted in the passages. The holders may include a main holder that lies in the electrically grounded frame, and that holds signal contacts at a predetermined spacing of their edges from each other and from the frame to achieve a characteristic impedance (e.g., 90 or 100 ohms).

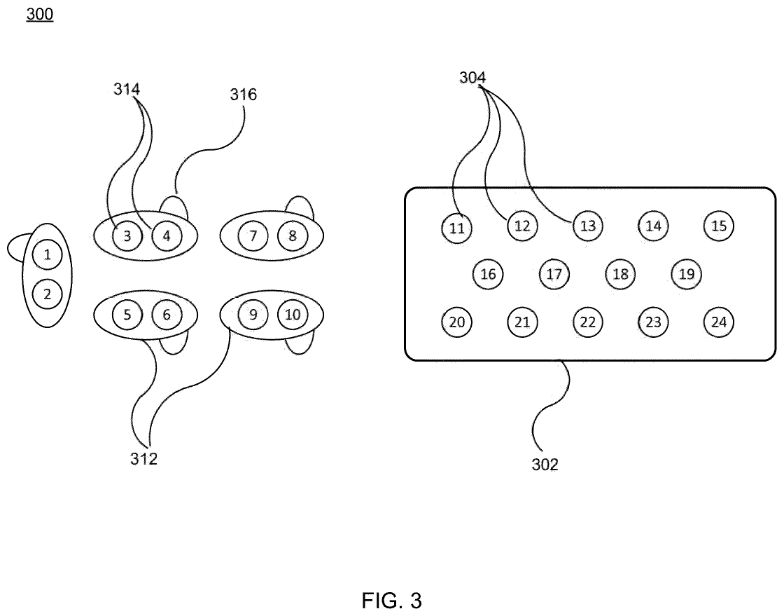

FIG. 3 illustrates front sectional view of an example high-speed modular interconnect system with individual contacts, arranged in accordance with at least some embodiments described herein.

As shown in diagram 300, the interconnect system includes a low-speed connector 302 and physically separate (but connected to the same cable bundle) high-speed connectors 312. In the low-speed connector 302, the signal contacts 304 (11-24) in the main holder, may be arranged in three rows, with the center row offset from the top and bottom rows, and with one fewer contact in the center row. This allows the main holder to have holder recesses at its ends. The grounded frame may have corresponding frame recesses at its opposite ends.

The high-speed connectors 312 may each include two contacts 314 (1-10). Each high-speed connector may also include an external polarity indicator 316 such as a protrusion. The high-speed connectors 312 may have any suitable shape, for example, an elongated elliptical shape, a rounded triangular shape, a rounded rectangular shape, etc. The polarity indicator 316 may also have any suitable shape such as a round shape, an elongated shape, a rectangular shape, etc.

In some examples, the low-speed connector 302 may include power signal contacts and low frequency signals. In some cases, medium frequency (in 100 kHz or even MHz range) signal contacts may also be included in the low-speed connector 302, but separated (through spacing, shielding, etc.) from the power and low frequency signal contacts. High-speed connectors may carry much higher frequency data signals. For example, high-speed connectors may include transmit and receive data pairs for digital radio communication, and similar ones. A number of high-speed connectors may vary depending on application, for example, from 1 to 10 or any other suitable and practical number. The signal contacts in the connectors may be pins or sockets depending on interconnect system configuration.

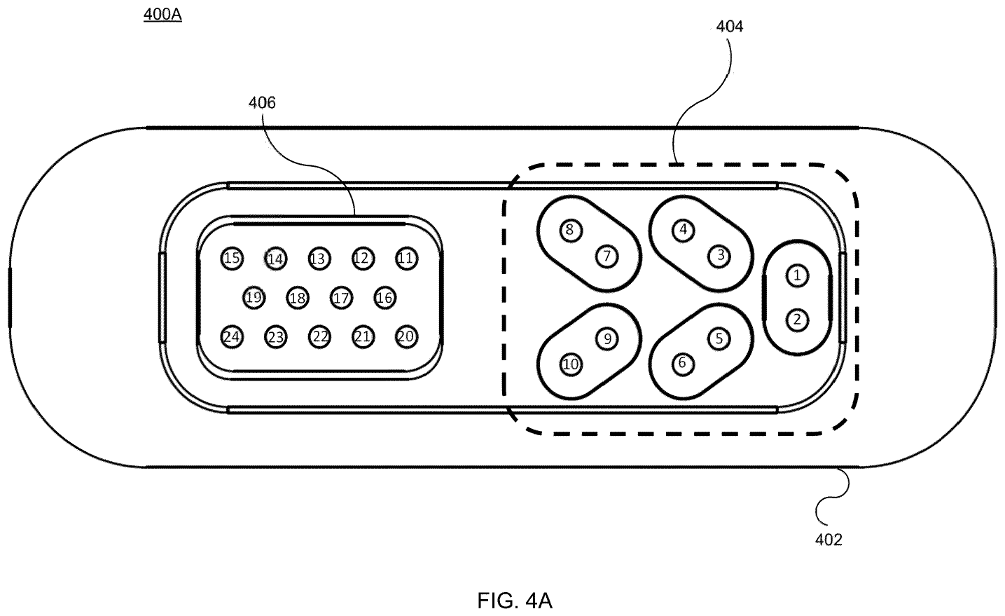

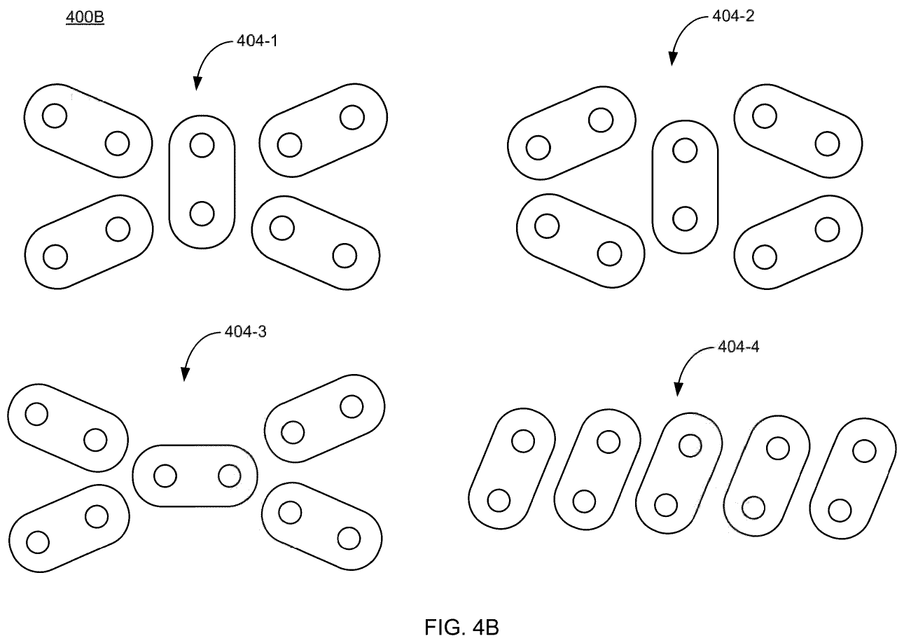

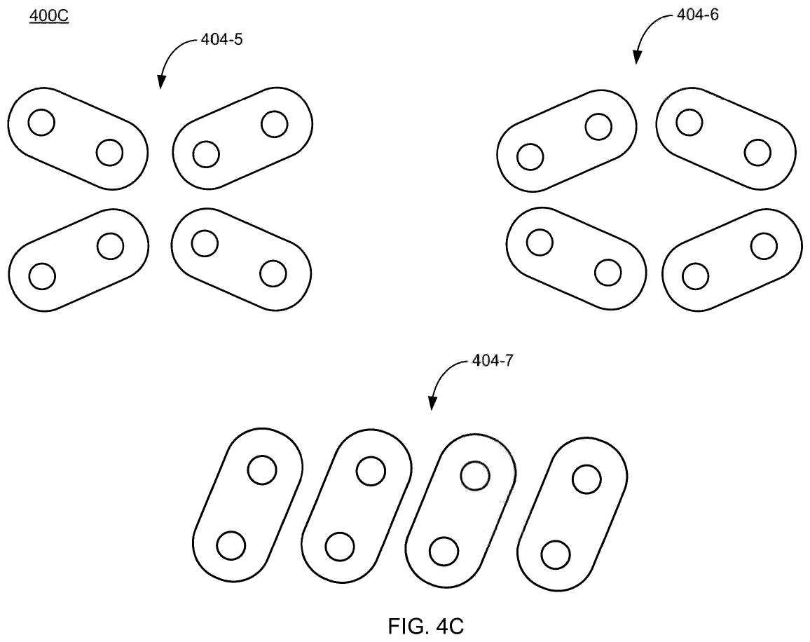

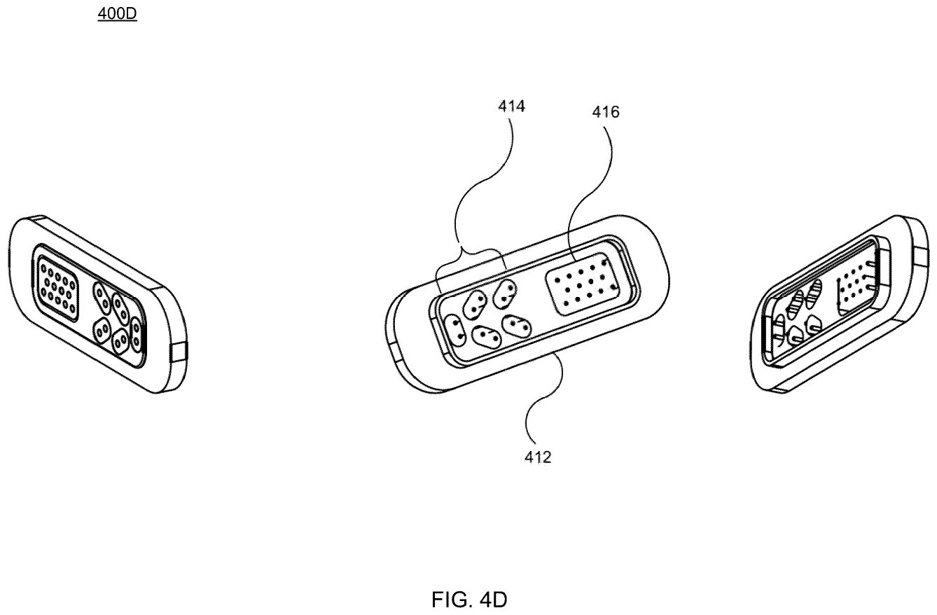

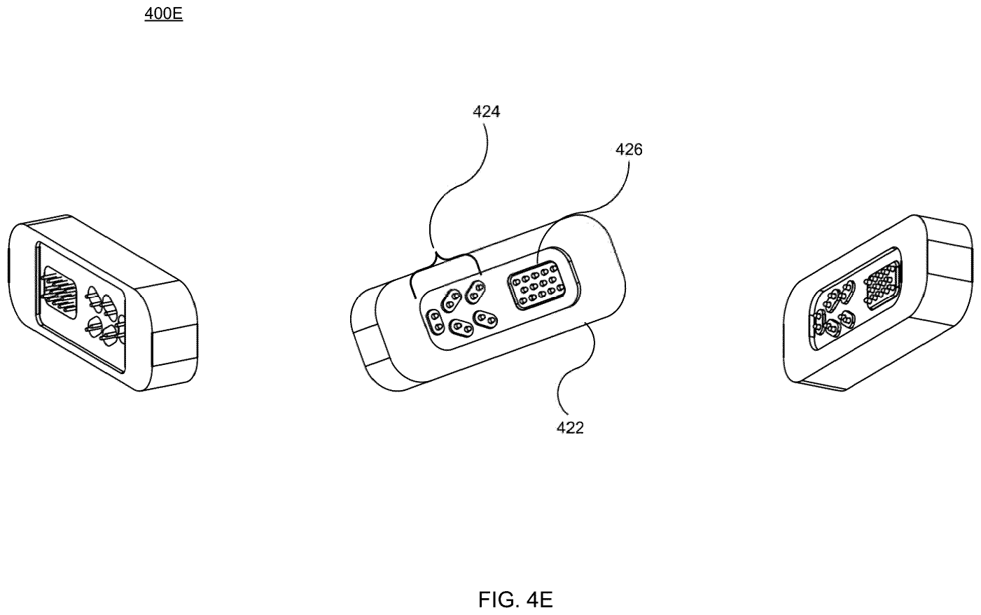

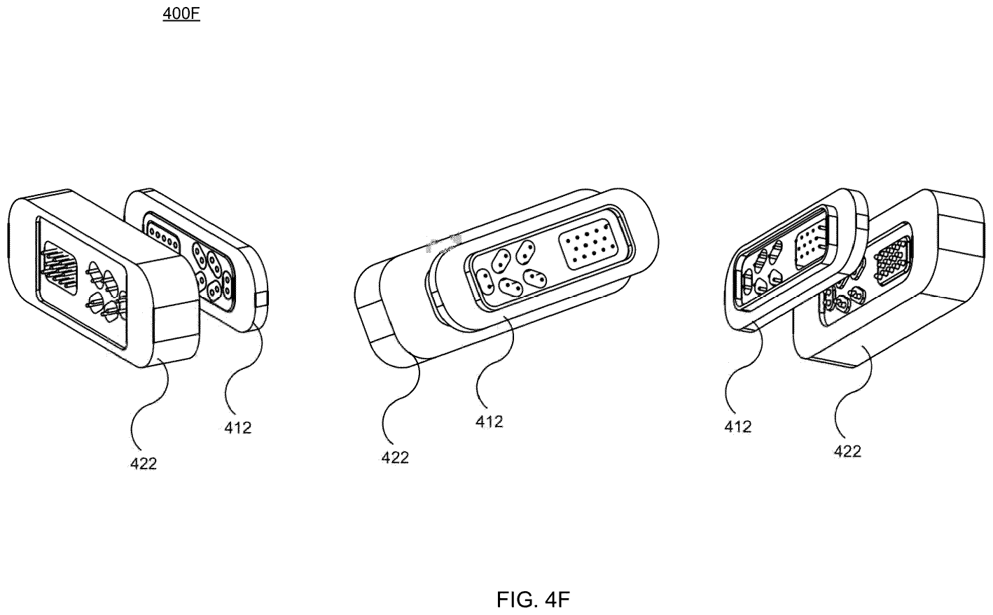

FIG. 4A through 4F illustrate various views of an example 24-position mix-mode modular interconnect system, arranged in accordance with at least some embodiments described herein.

Diagram 400A shows front view of a 24-position mix-mode modular interconnect system with high density portion 406, receive and transmit dual contact connections 404, and the shell 402 of the connector system. The high density portion 406 may include contacts for power and low frequency signals. In some cases, medium frequency (in 100 kHz or even MHz range) signal contacts may also be included in the high density portion 406, but separated (through spacing, shielding, etc.) from the power and low frequency signal contacts. Receive and transmit dual contact connections 404 may carry high frequency transmit and receive data for digital radio communication, and similar ones. While five pairs of receive and transmit dual contact connections 404 are shown in the example configuration of diagram 400A, any practical number of receive and transmit dual contact connections may be implemented. A layout, position, and orientation of the receive and transmit dual contact connections may also be varied depending on the connector type, application, connector/contact sizes, etc.

The receive and transmit dual contact connections 404 may be wired and shielded as discussed herein (e.g., individual or in groups). In addition to separate shielding, the increased spacing and varied orientations between the high density portion 406 and the receive and transmit dual contact connections 404 may allow reduction of interference between the power/low speed signals and high frequency data signals.

Diagram 400B shows various examples of layout, position, and orientation of the receive and transmit dual contact connections. As shown in the example configurations 404-1, 404-2, 404-3, and 404-4 of the diagram, any layout, position, number of dual contacts, and orientation may be selected for the receive and transmit dual contacts depending on a number of dual contacts, a type and size of the connector, a speed of data signals carried by the dual contacts, and/or an application (e.g., military, environmentally sealed, etc.). The example configurations 404-1, 404-2, 404-3, and 404-4 of diagram 400B are for five receive and transmit dual contact connection pairs. Diagram 400C shows various examples of layout, position, and orientation configurations 404-5, 404-6, and 404-7 of the receive and transmit dual contact connection pairs.

Diagram 400D shows various perspective views of a receptacle of the 24-position mix-mode modular interconnect system with connector shell 412, high density portion 416, and receive and transmit dual contact connections 414. Diagram 400E shows various perspective views of a plug of the 24-position mix-mode modular interconnect system with connector shell 422. The high density portion 426 and the receive and transmit dual contact connections 424 of the example plug connector mirror those of the example receptacle connector in diagram 400D and are arranged to mate with corresponding counterparts. Diagram 400F shows various perspective views of the mating pair of the receptacle 412 and the plug 422 of the 24-position mix-mode modular interconnect system.

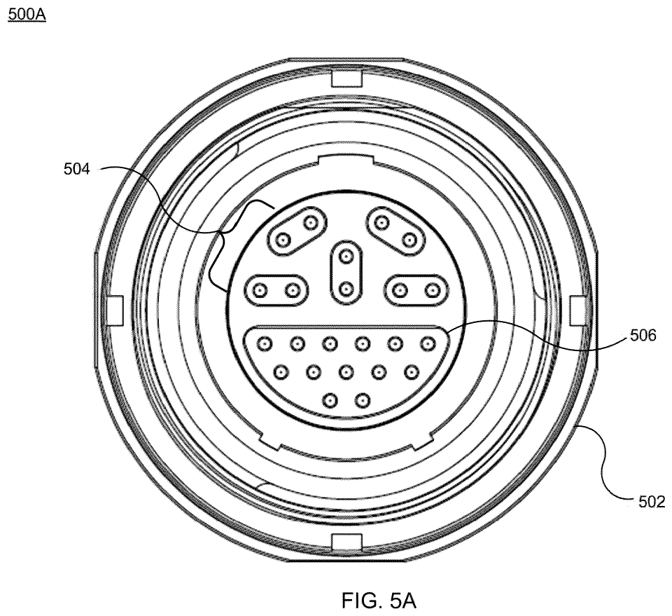

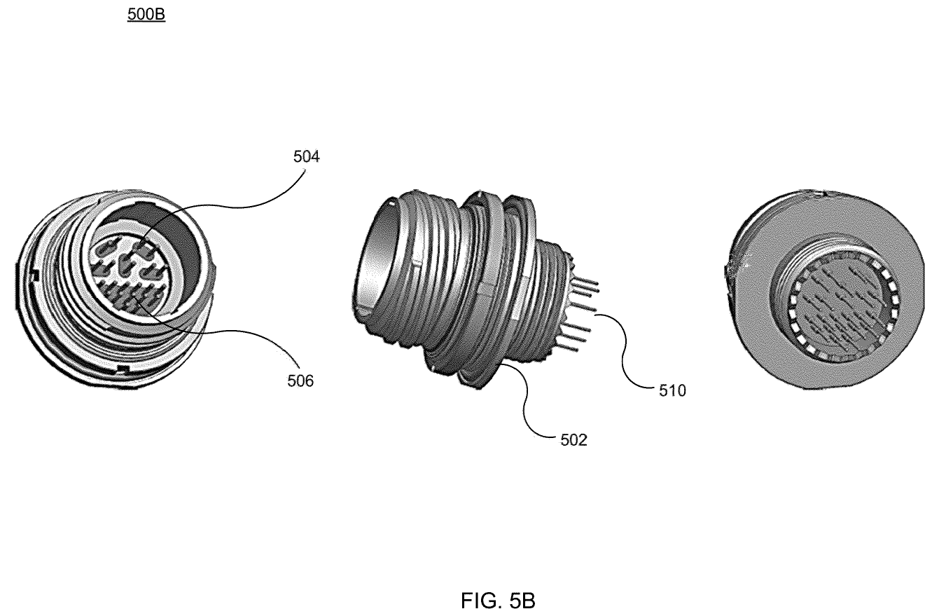

FIGS. 5A and 5B illustrate various views of an example 23-position circular mix-mode modular interconnect system, arranged in accordance with at least some embodiments described herein.

As mentioned herein, a mix-mode modular interconnect system may be implemented in any type, shape, size connector with any practical number of dual contact connections. Diagram 500A shows front view of an example 23-position circular mix-mode modular interconnect system with high density portion 506, receive and transmit dual contact connections 504, and the shell 502 of the circular connector system. As with the example connector system of FIG. 4A, the high density portion 506 may include contacts for power and low frequency signals, and optionally, medium frequency (in 100 kHz or even MHz range) signals. Receive and transmit dual contact connections 504 may carry high frequency transmit and receive data for digital radio communication, and similar ones. Location and orientation of the dual contacts are selected based on shape and size of the available space in the circular connector.

Diagram 500B shows various perspective views of a receptacle of the 23-position circular mix-mode modular interconnect system with high density portion 506 contacts shown as pins and receive and transmit dual contact pins 504. Contact pins 510 for wiring in the back of the connector 502 are also shown in the diagram. As mentioned above, other shapes, layouts, and contact numbers may also be implemented using the principles described herein.

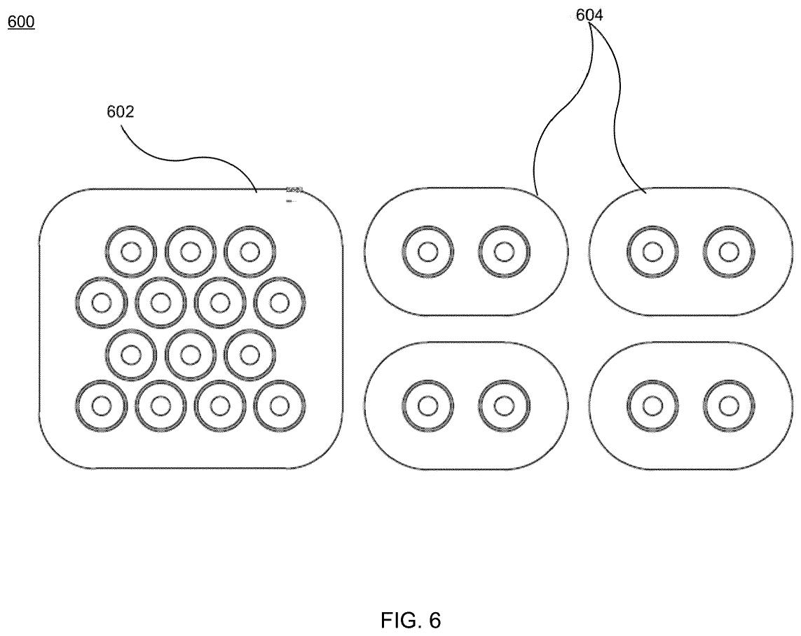

FIG. 6 illustrates an example 22-position circular mix-mode modular interconnect system, arranged in accordance with at least some embodiments described herein.

Diagram 600 shows a rear view of an example 22-position circular mix-mode modular interconnect system with high density portion contacts 602 and receive and transmit dual contacts 604. As mentioned above, other shapes, layouts, and contact numbers may also be implemented using the principles described herein.

The configurations shown herein are for illustration purposes only and are not intended as limitations on embodiments. A number of contacts (pins/sockets) may be any practical number depending on the size and functionality of the connector assemblies. Another consideration in selecting a number of the pins/sockets may be dimension and clearance requirements imposed by practical design considerations and/or standards. Additional features of the connector assembly such as shielding, heat resistance, insulation may also affect the number of pins/sockets to be combined by imposing limitations on the connector assembly dimensions and material types.

Some example performance parameters of example interconnect systems may include, but are not limited to, contact current ratings up to 10 A, operating voltage ratings up to 250 V, operating temperature ratings between about −65° C. and about 175° C., IP68 and IP6K9K environmental sealing, up to 500 cycle stamp contact rating for durability, up to 1800 V dielectric voltage rating, up to 300 g physical shock rating, etc. Example diameters of the wires may range from 30 AWG to 22 AWG in some implementations. Example interconnect systems may also be implemented with other performance parameters.

The holders may be made from plastic or thermoplastic materials such as glass filled polyamides, for example. Seals and interface gaskets may be made from elastic materials such as silicone rubber. Contacts may be made from copper alloy or stainless steel and may be nickel, tin, silver, or gold plated. The connector assemblies may be further ruggedized (resistance against vibration, wear and tear), environmentally protected (heat, dust, humidity, etc.), and/or shielded against electromagnetic and/or electrostatic disturbances.

According to some examples, a modular interconnect system may include a low-speed connector assembly that includes a conductive frame; a dielectric holder within the conductive frame, the dielectric holder having a plurality of longitudinally extending passages; a plurality of contacts within the plurality of passages; and a plurality of low-speed wires electrically connected to the plurality of contacts. The modular interconnect system may also include one or more high-speed connector assemblies, each high-speed connector assembly may include a conductive frame; a dielectric holder within the conductive frame, the dielectric holder having a pair of longitudinally extending passages; a pair of contacts within the pair passages; and a pair of high-speed wires electrically connected to the pair of contacts, where the plurality of low-speed wires are shielded together and each pair of high-speed wires are shielded together.

According to other examples, the shielded plurality of low-speed wires and the shielded high-speed wires are bundled together into an interconnect cable. The low-speed connector assembly is arranged to carry power and low-frequency signals below 100 kHz, and the one or more high-speed connector assemblies are arranged to carry high-speed data signals. The pair of contacts in each high-speed connector assembly is arranged as one of a differential signal pair or signal and ground pair of a single-ended signal. The one or more high-speed connector assemblies each include a mechanical polarity indicator. The mechanical polarity indicator is a protrusion having a round shape, an elongated shape, or a rectangular shape. The one or more high-speed connector assemblies have an elongated elliptical shape, a rounded triangular shape, or a rounded rectangular shape. A layout, a position, a number, or an orientation of the one or more high-speed connector assemblies is selected based on one or more of a connector system type, connector system size, a connector system shape, an application, or a contact size.

According to further examples, a modular high-speed connector assembly may include a conductive frame; a dielectric holder within the conductive frame, the dielectric holder having a pair of longitudinally extending passages; a pair of contacts within the pair passages arranged as one of a differential signal pair or signal and ground pair of a single-ended signal; and a pair of high-speed wires electrically connected to the pair of contacts and shielded together, where one or more modular high-speed connector assemblies are integrated with a low-speed connector assembly in a modular mix-mode interconnect system.

According to yet other examples, a plurality of low-speed wires for the low-speed connector assembly are shielded together and the shielded plurality of low-speed wires and the shielded high-speed wires are bundled together into an interconnect cable. The low-speed connector assembly is arranged to carry power and low-frequency signals below 100 kHz, and the one or more high-speed connector assemblies are arranged to carry high-speed data signals. The modular high-speed connector assembly may further include a mechanical polarity indicator. The mechanical polarity indicator is a protrusion having a round shape, an elongated shape, or a rectangular shape. The high-speed connector assembly has an elongated elliptical shape, a rounded triangular shape, or a rounded rectangular shape. A layout, a position, a number, or an orientation of the one or more high-speed connector assemblies is selected based on one or more of a connector system type, connector system size, a connector system shape, an application, or a contact size. A spacing of the one or more high-speed connector assemblies' edges from each other and from a modular mix-mode interconnect system frame is selected to achieve a characteristic impedance for the one or more high-speed connector assemblies. The one or more high-speed connector assemblies are one or more of ruggedized against vibration, wear, or tear; environmentally protected against heat, dust, or humidity; or shielded against electromagnetic or electrostatic disturbances within the modular mix-mode interconnect system.

According to some examples, a method of assembling a modular interconnect system may include assembling a low-speed connector assembly by positioning a first dielectric holder within a first conductive frame, the first dielectric holder having a plurality of longitudinally extending passages; positioning a plurality of contacts within the plurality of passages; and electrically connecting a plurality of low-speed wires to the plurality of contacts. The method may further include assembling one or more high-speed connector assemblies, by for each high-speed connector assembly, positioning a second dielectric holder within a second conductive frame, the second dielectric holder having a pair of longitudinally extending passages; positioning a pair of contacts within the pair passages; electrically connecting a pair of high-speed wires to the pair of contacts; shielding the plurality of low-speed wires together; and shielding each pair of high-speed wires together.

According to other examples, the method may further include bundling the shielded plurality of low-speed wires and the shielded high-speed wires together into an interconnect cable. The method may also include providing a mechanical polarity indicator, wherein the mechanical polarity indicator is a protrusion having a round shape, an elongated shape, or a rectangular shape.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A modular interconnect system comprising:
a low-speed connector assembly comprising:
a conductive frame;
a dielectric holder within the conductive frame, the dielectric holder having a plurality of longitudinally extending passages;
a plurality of contacts within the plurality of passages; and
a plurality of low-speed wires electrically connected to the plurality of contacts; and
one or more high-speed connector assemblies, each high-speed connector assembly comprising:
a conductive frame;
a dielectric holder within the conductive frame, the dielectric holder having a pair of longitudinally extending passages;
a pair of contacts within the pair passages; and
a pair of high-speed wires electrically connected to the pair of contacts, wherein
the plurality of low-speed wires are shielded together, and
each pair of high-speed wires are shielded together.

2. The modular interconnect system of claim 1, wherein the shielded plurality of low-speed wires and the shielded high-speed wires are bundled together into an interconnect cable.

3. The modular interconnect system of claim 1, wherein the low-speed connector assembly is arranged to carry power and low-frequency signals below 100 kHz, and the one or more high-speed connector assemblies are arranged to carry high-speed data signals.

4. The modular interconnect system of claim 1, wherein the pair of contacts in each high-speed connector assembly is arranged as one of a differential signal pair or signal and ground pair of a single-ended signal.

5. The modular interconnect system of claim 1, wherein the one or more high-speed connector assemblies each include a mechanical polarity indicator.

6. The modular interconnect system of claim 5, wherein the mechanical polarity indicator is a protrusion having a round shape, an elongated shape, or a rectangular shape.

7. The modular interconnect system of claim 1, wherein the one or more high-speed connector assemblies have an elongated elliptical shape, a rounded triangular shape, or a rounded rectangular shape.

8. The modular interconnect system of claim 1, wherein a layout, a position, a number, or an orientation of the one or more high-speed connector assemblies is selected based on one or more of a connector system type, connector system size, a connector system shape, an application, or a contact size.

9. A modular high-speed connector assembly comprising:
a conductive frame;
a dielectric holder within the conductive frame, the dielectric holder having a pair of longitudinally extending passages;
a pair of contacts within the pair passages arranged as one of a differential signal pair or signal and ground pair of a single-ended signal; and
a pair of high-speed wires electrically connected to the pair of contacts and shielded together, wherein
one or more modular high-speed connector assemblies are integrated with a low-speed connector assembly in a modular mix-mode interconnect system.

10. The modular high-speed connector assembly of claim 9, wherein
a plurality of low-speed wires for the low-speed connector assembly are shielded together, and
the shielded plurality of low-speed wires and the shielded high-speed wires are bundled together into an interconnect cable.

11. The modular high-speed connector assembly of claim 9, wherein the low-speed connector assembly is arranged to carry power and low-frequency signals below 100 kHz, and the one or more high-speed connector assemblies are arranged to carry high-speed data signals.

12. The modular high-speed connector assembly of claim 9, further comprising:
a mechanical polarity indicator.

13. The modular high-speed connector assembly of claim 12, wherein the mechanical polarity indicator is a protrusion having a round shape, an elongated shape, or a rectangular shape.

14. The modular high-speed connector assembly of claim 9, wherein the high-speed connector assembly has an elongated elliptical shape, a rounded triangular shape, or a rounded rectangular shape.

15. The modular high-speed connector assembly of claim 9, wherein a layout, a position, a number, or an orientation of the one or more high-speed connector assemblies is selected based on one or more of a connector system type, connector system size, a connector system shape, an application, or a contact size.

16. The modular high-speed connector assembly of claim 9, wherein a spacing of the one or more high-speed connector assemblies' edges from each other and from a modular mix-mode interconnect system frame is selected to achieve a characteristic impedance for the one or more high-speed connector assemblies.

17. The modular high-speed connector assembly of claim 9, wherein the one or more high-speed connector assemblies are one or more of ruggedized against vibration, wear, or tear; environmentally protected against heat, dust, or humidity; or shielded against electromagnetic or electrostatic disturbances within the modular mix-mode interconnect system.

18. A method of assembling a modular interconnect system, the method comprising:
assembling a low-speed connector assembly by:
positioning a first dielectric holder within a first conductive frame, the first dielectric holder having a plurality of longitudinally extending passages;
positioning a plurality of contacts within the plurality of passages; and
electrically connecting a plurality of low-speed wires to the plurality of contacts; and
assembling one or more high-speed connector assemblies, by:
for each high-speed connector assembly, positioning a second dielectric holder within a second conductive frame, the second dielectric holder having a pair of longitudinally extending passages;
positioning a pair of contacts within the pair passages;
electrically connecting a pair of high-speed wires to the pair of contacts;
shielding the plurality of low-speed wires together; and
shielding each pair of high-speed wires together.

19. The method of claim 18, further comprising:
bundling the shielded plurality of low-speed wires and the shielded high-speed wires together into an interconnect cable.

20. The method of claim 18, further comprising:
providing a mechanical polarity indicator, wherein the mechanical polarity indicator is a protrusion having a round shape, an elongated shape, or a rectangular shape.
